(19) United States
(12) Patent Application Publication
(10) Pub. No.: US 2011/0031371 A1
(43) Pub. Date: Feb. 10, 2011

(54) LOAD TAKE-UP DEVICE FOR INTRODUCING LOAD FORCES SUCH AS CABLE FORCES OR TENSION FORCES OF FLAT STRUCTURES

(76) Inventor: Helmut Rube, Sussen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/736,483

(22) PCT Filed: Mar. 27, 2009
(86) PCT No.: PCT/EP2009/002252

§ 371 Date: Oct. 13, 2010

(30) Foreign Application Priority Data
Apr. 21, 2008 (DE) 10 2008 019 912.5

(51) Int. Cl. F16M 13/02

(52) U.S. Cl. 248/499

(57) ABSTRACT

A load take-up device for introducing load forces such as cable forces or tension forces of flat structures onto support structures (10, 41), comprising at least one load take-up part (17) anchored or anchorable thereon, said load take-up part forming at least one transfer surface (34) for the engagement of a pulling means (1), is characterized in that the transfer surface (34) is designed at least partially in a convex manner or comprises surface areas that are circumscribed by a convex curved envelope.

The invention relates to a load take-up device for introducing load forces, such as cable forces or tension forces of flat structures, into support structures and that comprises at least one load bearing member, which is anchored or is anchorable thereon and which forms at least one transfer surface for the engagement of a tensioning mechanism.

Modern architecture has increasingly incorporated concepts of load bearing structures, where flat elements, such as tent-like or umbrella-like coverings that form, as a textile building material, part of a load bearing structure, are anchored or clamped to support systems, for example, steel supports. In order to achieve that the respective elements form space-creating structures of a desired architectural design, the respective suitable introduction of load forces, in particular, the tensioning or bearing cable forces, is a crucial factor. Hence, it must be ensured that the line of action of the cable force that is to be transferred and that engages with the respective support system is independent of the respective orientation (inclination) of the support that is a part of the load bearing structure, in order to avoid distortions of the desired architectural design.

Working on this basis, the object of the invention is to provide a load bearing device that satisfies, in particular, the associated requirements.

The invention achieves this engineering object with a load bearing device having the features disclosed in patent claim 1 in its entirety.

Accordingly, one essential feature of the invention lies in the fact that the transfer surface is designed at least partially in a convex manner or is formed by surface parts that are circumscribed by a convexly curved envelope on the load bearing member. Owing to the interaction with an assigned concavity of a support surface of the tensioning mechanism, the load is transferred over a ball joint-like connection that is essentially free of lateral forces in the event of different directions of tension. This feature enables an optimal connection of the flat structures to be tensioned without the risk of creating distortions because of the influence of lateral forces. The overlapping of the transfer surface on the load bearing member due to a concavity, defining the support surface, on the tensioning mechanism offers security against unhooking, irrespective of the point, at which the line of action of the tension force intersects the arched transfer surface on the load bearing member.

In order to implement this design, the load bearing member can be configured as a spheroid. The concept “as a spheroid” is defined in the present context as not only a spheroid body in the strict sense, like a smooth sphere or hemisphere, but also any sphere-like arched body, possibly also with a cross section that is oval in some regions, or in the form of a sphere-like body, of which the surface is contoured, for example, ribbed or grooved. In this case, the peak regions form surface areas that circumscribe a convexly curved envelope.

The transfer surface can also be, in particular, a spherical surface, which forms part of a spherical body and which can interact with a type of spherical hook on the tensioning mechanism, where the support surface is formed by parts of a spherical cap.

In especially advantageous embodiments, the spherical surface is formed on a spherical part, which forms the load bearing member and which can be connected to the support structure by means of an anchoring element. However, in the case of components that are provided from the start for the interaction with a load bearing member of the invention, it is as possible for its anchoring element to be molded directly onto the support structure.

The arrangement can also be configured in such a way that the surface areas, which form the transfer surface and which are circumscribed by a convexly curved envelope, are offset from each other by surface areas that are recessed in the load bearing member. As a result, the support surface of the tensioning mechanism engages with the surface areas on the load bearing member. In this case, there are recessed regions between the surface areas. These regions can form receiving compartments for particles like sand, soot, or the like, when the load bearing device is used under unfavorable environmental conditions, especially when there is a high risk of soiling.

In this respect, the arrangement can be configured in such a way that surface areas on the load bearing member that are offset from each other are formed by ring ribs, which extend, based on the axis of the anchoring element, in radial planes at a distance from each other, and/or by ribs, which form ring segments and which extend from the anchoring element in a mutually diverging manner and are separated from each other by depressions. It is also possible to provide a pattern of ribs and depressions, for example, in that the ribs, extending in radial planes, are interrupted by depressions that extend from the shank section in a mutually diverging manner and intersect the ribs at right angles.

In embodiments in which the load bearing member can be connected to the support structure by means of an anchoring element, the anchoring element that is provided is preferably a shank section that projects beyond an outer surface of the support structure. The end of the shank section is attached to the spherical part that is connected as one piece to said shank section. The spherical part, which projects beyond the outer surface of the structure, offers, irrespective of whether the spherical part is attached to the end of a shank section or is molded directly on the structure, the possibility of also engaging laterally with a support structure, i.e., with a direction of tension that extends along the outer surface of the structure. The invention is characterized by an especially wide variety of possible applications.

In advantageous embodiments, the shank section terminates in a threaded journal that can be screwed together with the support structure. As a result, the load bearing member can be connected especially easily and reliably to support structures and can be easily removed from the same so that it is available, if desired, for reuse.

In especially advantageous embodiments, the shank section has an expansion in the form of a collar on the end of the threaded journal that is adjacent to the spherical part. The diameter of the collar is larger than that of the threaded journal. The collar forms a support surface for making contact with the outside of the support structure that is screwed together with the threaded journal. As a result, the shank section is effectively reinforced against bending moments that occur when load forces engage with directions of tension that are sloped at an angle in relation to the axis of the shank section. Therefore, with the invention, it is possible to transfer load forces that can be directed even 90 degrees in relation to the axis of the shank section of the load bearing member.

Preferably, the diameter of the collar is about twice the size of the diameter of the threaded journal, and the diameter of the spherical body of the spherical part is also preferably about twice the size of the diameter of the threaded journal.

The arrangement can be configured in such an especially advantageous way that the tensioning mechanism has a spherical hook with a spherical support housing, in which the spherical part and a portion of the shank section that is a part of the load bearing member and that borders said spherical part can be accommodated. The interior of said housing has parts of a spherical cap, which forms with its spherical surface parts alone or with the surface parts, which project radially from the spherical surface parts, the support surface for the interaction with the transfer surface on the spherical part of the load bearing member.

In especially advantageous embodiments, the spherical support housing can have a receiving compartment, which surrounds the spherical part and the adjacent shank section in the hooked-together state with the load bearing member.

Such a housing can be designed like a bell with an upper part opposite the bottom part. In this case, the upper part has an engagement point for the tension force generated by the tensioning mechanism, for example, in the form of a cable, so that the line of action of the tension force defines a main axis of the spherical support housing that extends from the bottom part to the upper part. At the same time, the arrangement can be configured in such a way that the recesses for the movements of the load bearing member into and out of the interior of the spherical support housing prescribe a direction of movement that is perpendicular to the main axis. The result is a spherical hook, where the hooking together action is achieved by a movement relative to the load bearing member, and this movement runs transversely to the main axis of the spherical support housing.

The recesses that are provided for the above purpose in the spherical support housing can be formed by a slit, located in the bottom part and having a width that enables the passage of the shank section of the load bearing member, and by an aperture in the side wall. This aperture, connected to the slit, enables the passage of the spherical part of the load bearing member.

While under load, the spherical part is prevented from leaving the spherical support housing due to the contouring of the interacting surfaces, provision may be made to ensure that an unintentional release does not occur when there is no tension force. To this end, especially advantageous embodiments can provide that the upper part of the spherical support housing has a flap that can be swiveled about an axis that runs perpendicular to the main axis and to the longitudinal direction of the slit. This flap can be moved into a position that partially blocks the aperture in order to ensure the hooked-together state, or this flap can be moved into a position that releases the aperture, with the flap being preferably biased in the direction of the blocking position.

In more modified embodiments, the spherical support housing is not formed as a uniform bell body, but rather the arrangement is configured in such a way that the upper part of the spherical support housing forms a swivel bearing, which is connected to the engagement point for the tension force generated by the tensioning mechanism, for two shell-shaped halves of the housing. These housing halves can be swiveled between an unhooked position, in which the two halves are swung away from each other, and a hooked position, in which the two halves are swung back together so as to rest against each other, thus forming the receiving compartment, which in the hooked-together state surrounds the spherical part of the load bearing member while simultaneously releasing only the shank section bordering the spherical part. In such an embodiment there are spherical caps for the interaction with the transfer surface of the spherical part situated in the receiving compartment in order to form the support surface on the insides of the shell bodies.

The invention is explained in detail below with reference to the embodiments depicted in the drawings.

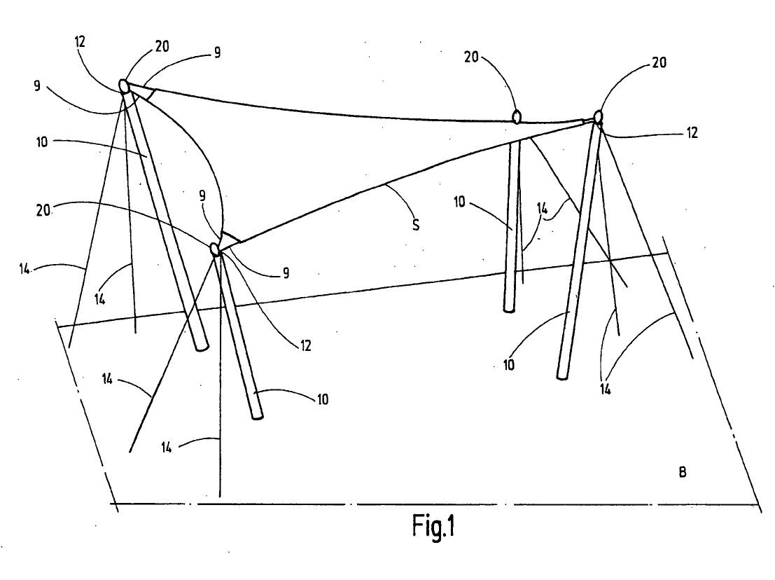

FIG. 1 is a highly simplified schematic diagram of a perspective oblique view of a roof covering composed of a sail clamped onto columns by means of load bearing devices of the invention.

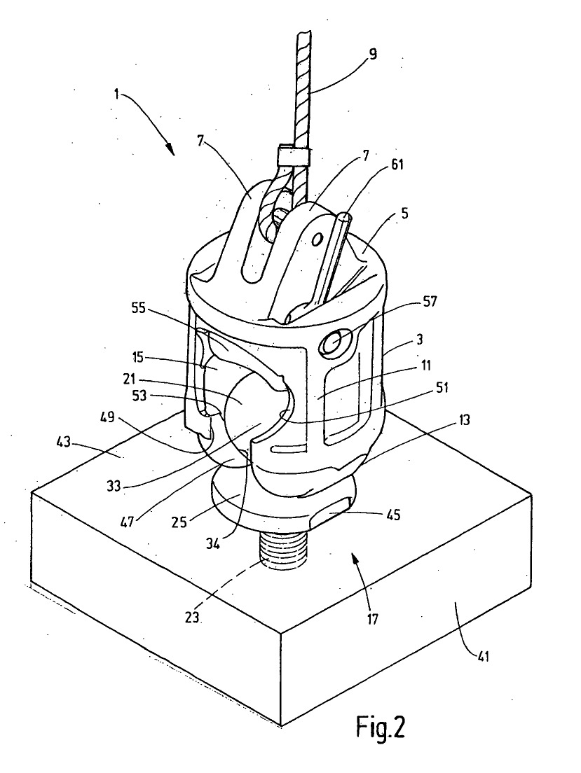

FIG. 2 is a perspective oblique view, shown on an enlarged scale compared to a practical embodiment, of an embodiment of the load bearing device according to the invention with the hooked-together state being shown.

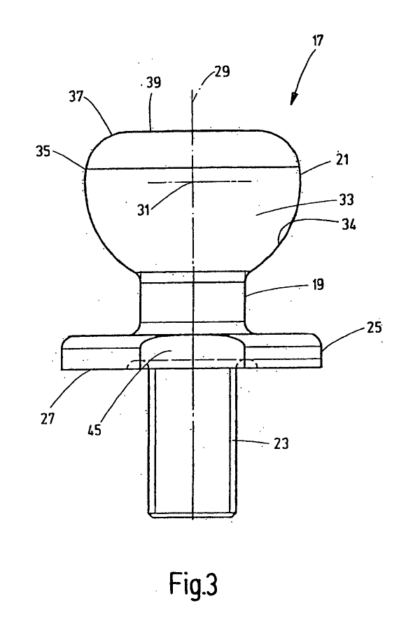

FIG. 3 is a side view, shown on a greatly enlarged scale compared to a practical embodiment, of just the load bearing member.

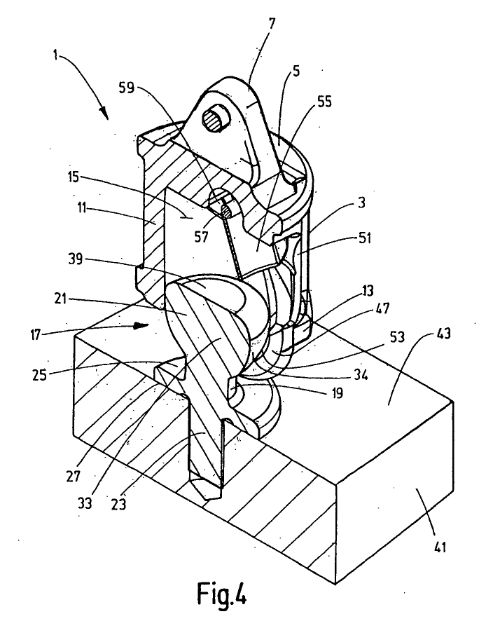

FIG. 4 is a drawing, shown as a perspective oblique view and cut longitudinally in the middle, of the hooked-together state, depicted in FIG. 2, with the section plane running in the longitudinal direction of a slit, configured in the bottom part of a spherical support housing.

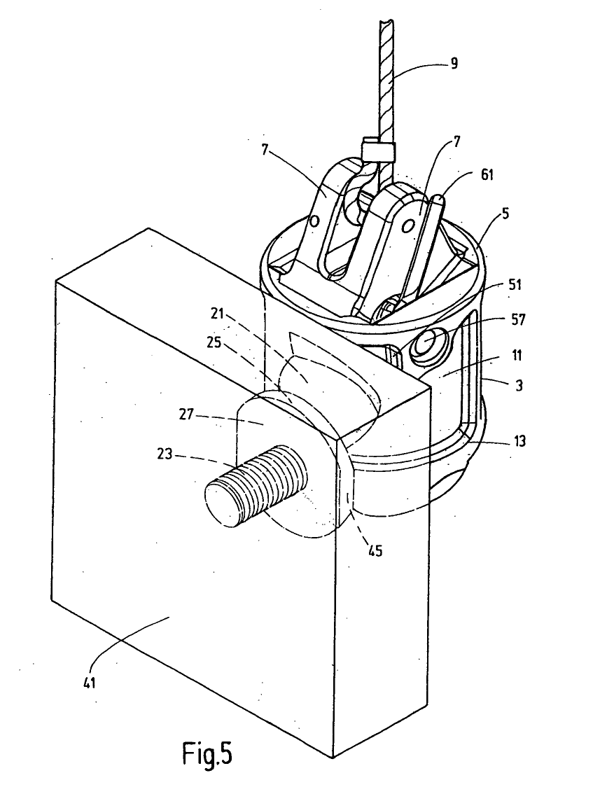

FIG. 5 is a drawing, similar to the one depicted in FIG. 2, of the hooked-together state, with the load bearing member being accessible from a side wall of a support structure.

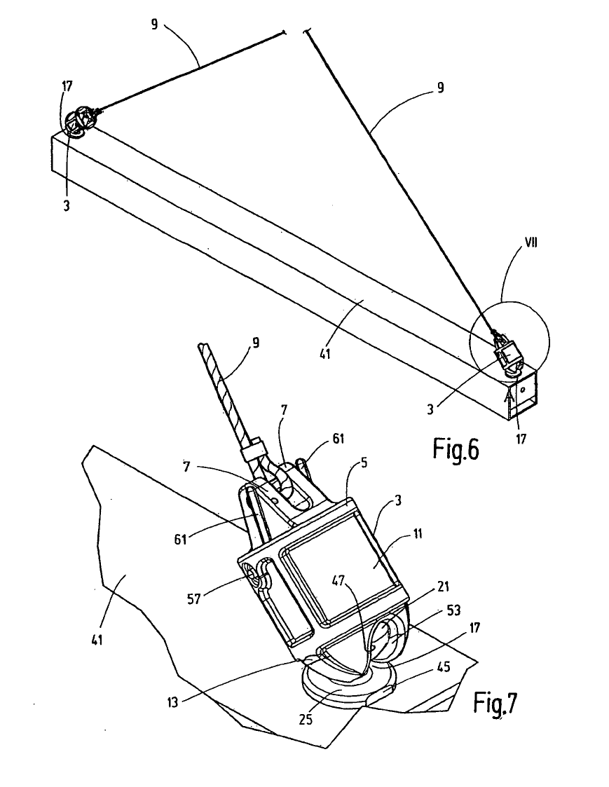

FIG. 6 is a perspective oblique view of a suspension formed with the use of the embodiment of the load bearing device.

FIG. 7 is a partial view, shown on an enlarged scale compared to FIG. 6, of only the region designated with the numeral VI in FIG. 6.

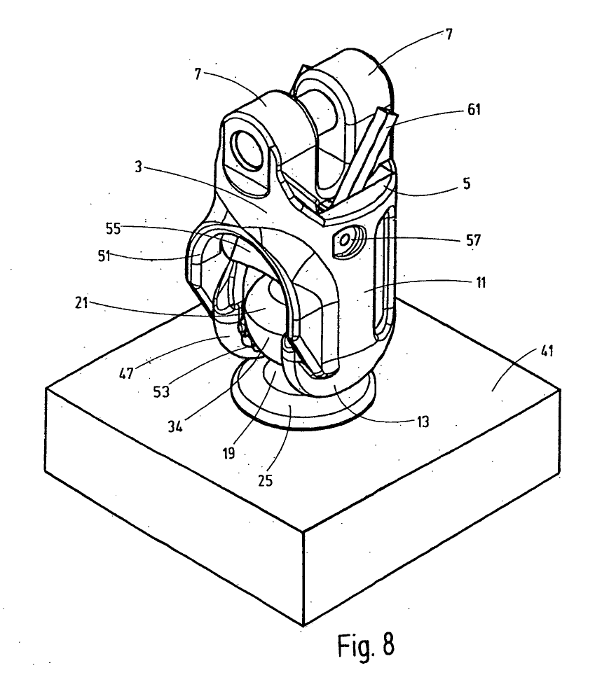

FIG. 8 is a drawing, similar to that in FIG. 2, of the hooked-together state, with a modified example of a spherical support housing being shown as a perspective oblique view.

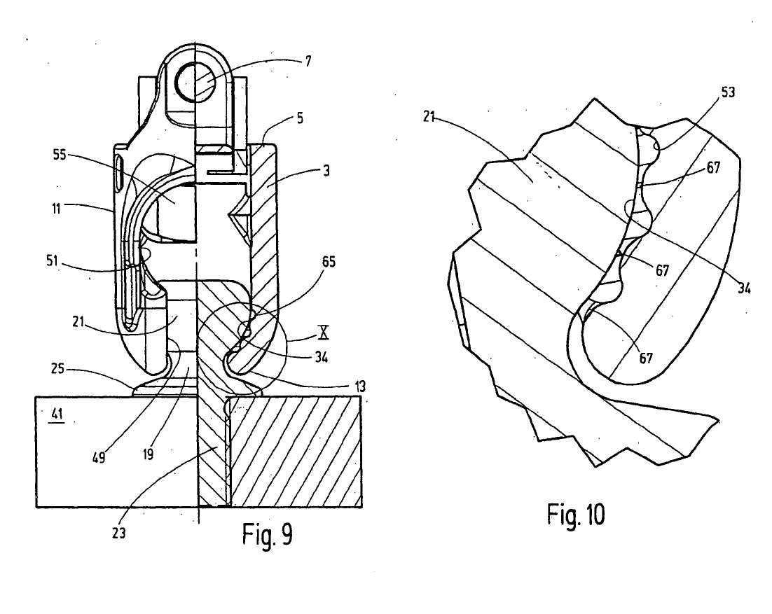

FIG. 9 shows a half longitudinal section of the hooked-together state depicted in FIG. 8.

FIG. 10 is a partial cutout, shown on a greatly enlarged scale, of the region designated with the numeral X in FIG. 9.

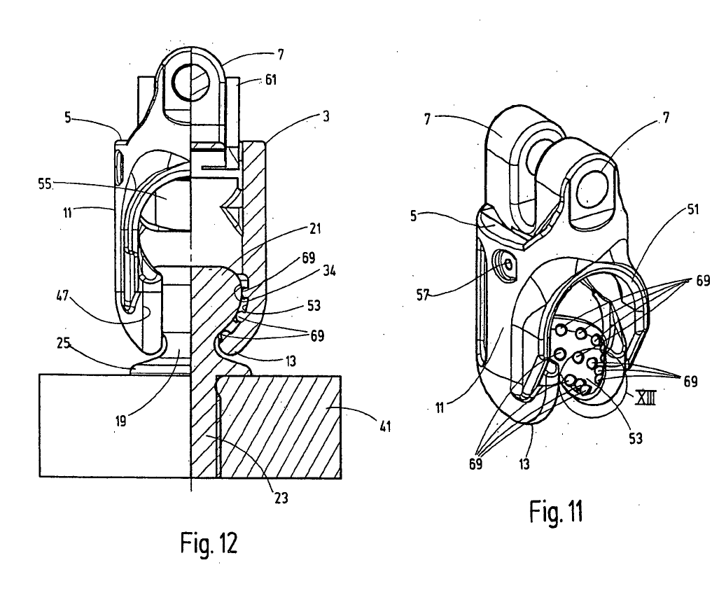

FIG. 11 is a perspective oblique view of just a modified embodiment of a spherical support housing.

FIG. 12 shows a half longitudinal section, similar to the one in FIG. 9, of the hooked state of the spherical support housing from FIG. 11 and the hooked load bearing member.

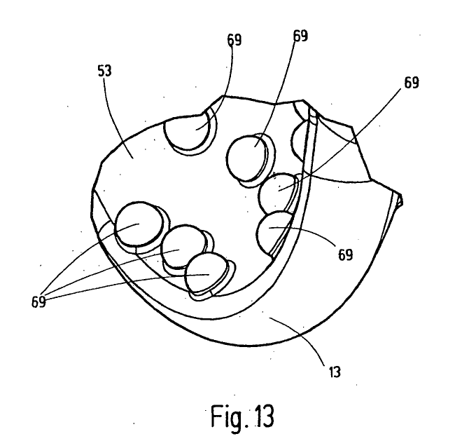

FIG. 13 is a greatly enlarged partial view of just the region that is designated with the numeral XIII in FIG. 11.

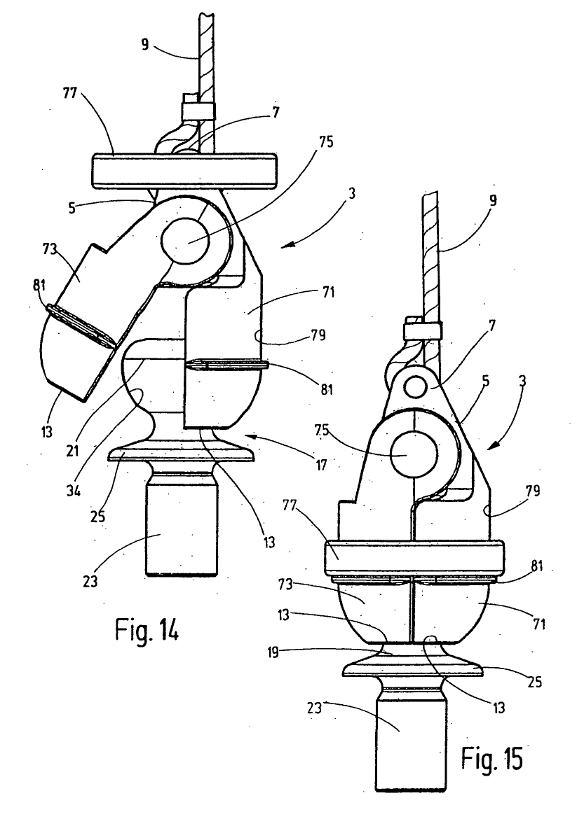

FIG. 14 is a side view of a more modified embodiment of a spherical support housing in the partially open state prior to being completely hooked together with the load bearing member.

FIG. 15 shows the state in which the spherical support housing from FIG. 14 is completely hooked together with the load bearing member.

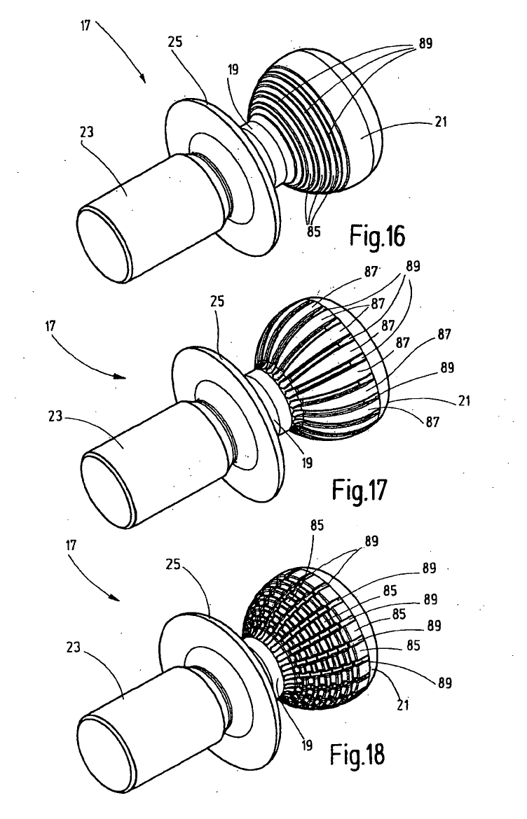

FIGS. 16 to 18 are perspective oblique views of three additional embodiments of the load bearing member.

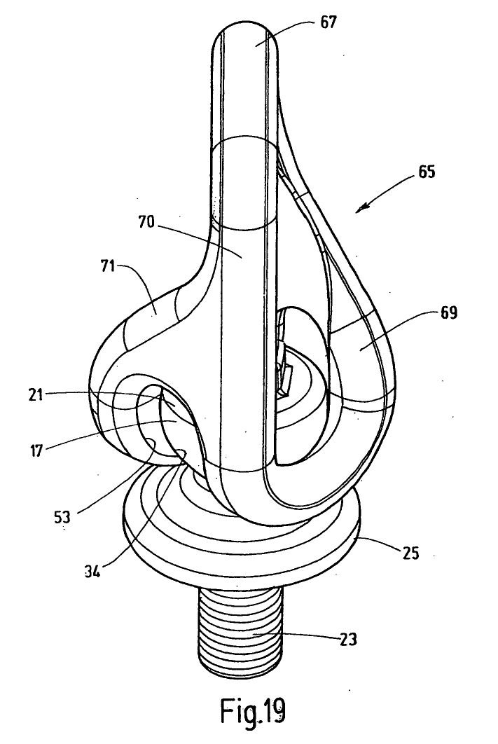

FIG. 19 is a perspective view, shown on an enlarged scale compared to a practical embodiment, of another embodiment of the load bearing device according to the invention.

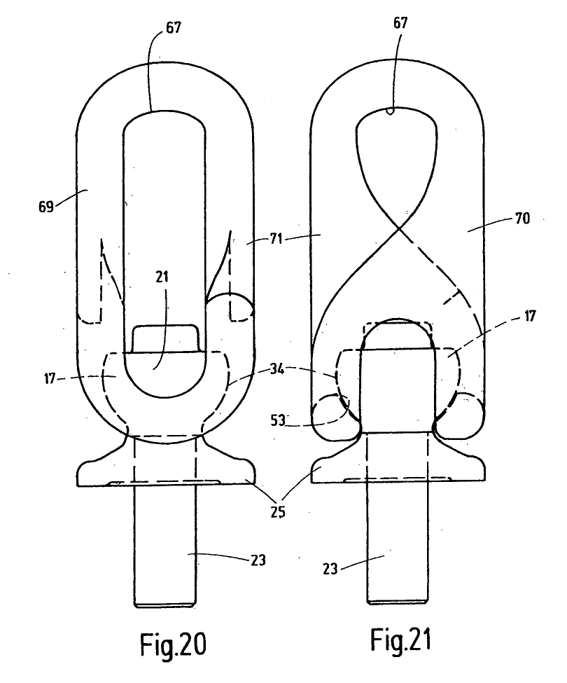

FIGS. 20 and 21 are a rear view and a side view respectively of the embodiment from FIG. 19.

FIG. 1 is a highly simplified schematic diagram of a flat load bearing structure having a surface structure in the form of a sail S that has an approximately rectangular contour and is made of a textile material that forms a tent-like or umbrella-like roof surface. The sail S is clamped to a support structure comprising steel supports 10 that are assigned to each corner region of the sail S. Each steel support stands on a ground surface B so as to slope outward to some extent and is stayed on this ground surface by means of tensioning cables 14. In order to transfer the tension forces, tensioning the sail S, into the steel supports 10, the free end 12 of each support 10 has two inventive load bearing devices, which are not depicted in detail in FIG. 1, but rather are merely shown as a skeletal outline at 20 in the diagram. The tension force, tensioning the sail S, is transferred into each of the two load bearing devices 20, located on each steel support 10, by means of a tensioning mechanism, of which FIG. 1 shows just one steel cable 9 in each instance. The design of the tensioning mechanisms and their assigned load bearing device is explained by means of the other figures.

FIG. 2 shows one of these tensioning mechanisms, which is designated as a whole as 1 and has a metal spherical support housing 3. The upper end of this housing is closed by an upper part 5, which is designed as one piece with the rest of the housing as a circular cover plate, which has leg-like extensions 7, which project upward at a distance from each other. Between these extensions there is an engagement point for the associated steel cable 9. A side wall 11, which forms a kind of bell-shaped shell, extends from the round upper part 5 as far as to a bottom part 13 of the spherical support housing 3. Inside the wall 11, there is a receiving compartment 15 between the upper part 5 and the bottom part 13. This receiving compartment extends more or less in an approximately circular cylindrical manner from the upper part 5 toward the bottom part 13. However, this circular cylindrical shape ends just before the inside of the bottom part 13. Extending from this bottom end of the circular cylindrical shape, the interior of the bottom part 13 forms the concave support surface for the interaction with the convex transfer surface of an assigned load bearing member 17, the details of which will be discussed below, in particular, with reference to FIGS. 3 and 4. FIG. 3 depicts separately the load bearing member, which is designated as a whole as 17 and which shall be described herein according to one embodiment of the invention. The load bearing member 17 is a one-piece, rotationally symmetrical metal part and has three main parts, specifically, a circular shank section 19 comprising a spherical part 21 attached to the end that is located at the top in the drawing and comprising a threaded journal 23 attached to the other end that is located at the bottom. The shank section 19 serves as the anchoring element for anchoring to a support structure.

At the transition from the shank section 19 into the threaded journal 23, there is a collar 25, which forms a circular ring flange. In the illustrated example, the diameter of said collar is larger than the diameter of the spherical part 21 and about twice as large as the diameter of the threaded journal 23. On its underside facing the threaded journal 23, the collar 25 forms a flat ring surface, the function of which will be explained below. The spherical part 21 forms, based on a center of curvature 31 that is located on the vertical axis 29, a part of a spherical body 33, which extends from the end of the shank section 19 as far as to an annular region 35, where the curvature undergoes transition, as compared to the conventional spherical radius, into a radius of curvature that is smaller by a factor of 2.5 in the illustrated example than the radius of the spherical body 33. Adjoining the end of this part 37 with the more pronounced curvature, there is a planar flattening 39 as the end face of the spherical part 21.

FIG. 4 shows the state in which the tensioning mechanism 1 is hooked together with the load bearing member 17, which is screwed to the support structure 41 by means of the threaded journal 23 of said load bearing member in such a way that the shank section 19 projects beyond the flat outside 43 of the support structure 41. FIGS. 2 and 4 show that in this case the annular surface 27 on the collar 25, which forms an expansion of the shank 19, rests against the outside 43 of the support structure 41 as the buttressing surface. In order to produce the screwed connection between the threaded journal 23 and the support structure 41, the collar 25 in the illustrated example has two diametrically opposing flattenings 45, which make it possible to tighten the screwed connection with a turning tool, such as an open-end wrench. As an alternative, the head-sided flattening 39 could have a hexagon socket or head.

The design of the inside of the bottom part 13 of the spherical support housing 3 is clearly visible in FIGS. 2 and 4. As shown, the bottom part 13 has a central, continuous straight slit 47, of which the width is slightly larger than the diameter of the shank section 19 of the load bearing member 17. As a result, the slit 47 forms a lead-in track, along which the load bearing member 17 can be transferred into the interior of the receiving compartment 15. To make this feature possible, the end 49 of the slit 47 that forms an entry region has an aperture 51 that is configured in the side wall 11 of the spherical support housing 3. This aperture 51 forms a kind of round window that extends as far as into the proximity of the upper part 5. The window size of this aperture 51 is chosen in such a way that, when the shank 19 of the load bearing member 17 is inserted along the slit 47, the spherical part 21 can enter into the receiving compartment 15 through the aperture 51.

As stated above, the inside of the bottom part 13 is configured such that there are concave surface parts that for the abutment of the convex transfer surface 34 of the load bearing member 17 form a support surface for the transfer of the tension force. For this purpose, each side of the slit 47 has parts of a spherical cap 53 that are adapted to the transfer surface 34 on the spherical body 21 of the load bearing member 17 in such a way that under load a coupling connection in the form of a ball joint arrangement is formed between the spherical part 21 and the spherical support housing 3. The interaction between the convexity on the spherical part 21 and the concavity on the spherical support housing 3 enables not only the reliable force transfer in any rotational position of the spherical support housing 3 in relation to the load bearing member 17, but also at different angles of inclination between the main axis of the spherical support housing 3 and the axis 29 of the load bearing member 17, so that the shank 19 of said load bearing member moves inside the slit 47 of the spherical support housing 3. This interaction between the spherical part 21 and the spherical cap surfaces 53 prevents the positive locking envelopment of the effective surface of the spherical body 21 from unhooking under load, and, in particular, up to angles of inclination exceeding 90 degrees, so that it is also possible to engage laterally, if desired, with a respective support structure 41 in the same way as shown in FIG. 5.

In order to prevent the spherical part 21 from unintentionally leaving the spherical support housing 3, which would be possible in the absence of a tension force, the present example provides a kind of hook securing mechanism that provides a detent flap 55 that is swivel-mounted about an axis 57 that extends perpendicular to the main axis of the spherical support housing 3 inside a recess 59 in the upper part 5 and extends perpendicular to the longitudinal direction of the slit 47 in the bottom part 13. The flap 55 that is mounted in this way can be swiveled, as shown in FIGS. 2 and 4, into a detent position that partially closes the aperture 51. In this position the load bearing member 17 cannot be moved out, because, when it is moved out along the cap surfaces 53, the spherical part 21 moves upward in relation to the receiving compartment 15, so that the spherical part 21 strikes against the flap 55. On the other hand, it is possible for the load bearing member to leave, if the flap 55 is swiveled from the illustrated detent position into the interior of the receiving compartment 15. In the present example, the flap 55 is spring-biased in the direction of the illustrated detent position. For this purpose, a torsion spring, which is located in the interior of the recess 59, and is, therefore, not visible in the figure, is situated on the axis 57. FIGS. 2, 5, and 7 show an actuating lever 61, which projects outward beyond a slit opening in the upper part 5 and is connected to the flap 55. This flap 55 can be swiveled against the spring force by means of this actuating lever, so that the unhooking operation can be performed.

The possibility of engaging with the support structures 41 when the spherical support housing 3 is in any rotational position and at various angles of inclination offers not only the possibility of engaging laterally, as shown in FIG. 5, with a respective structure 41, but also enables the formation of any suspension, in order to engage, if it is desired and/or practical, with a plurality of points, as shown in FIGS. 6 and 7. As illustrated, the engagement with a support structure 41 occurs in the form of a girder or beam at two load bearing members 17 that are positioned at opposite ends of the structure 41. In this case, two spherical support housings 3 with one cable 9 in each case engage with the structure 41; and the cable 9 extends so as to slope in relation to each other and the structure 41. FIG. 7 also shows a special feature compared to the drawing in FIGS. 2 and 5. That is, both sides of the legs 7, located on the upper part 5 of the spherical support housing 3, have an actuating lever 61 in each case, so that the actuation of the flap 55 is especially easy to perform from both sides.

Whereas, in the case of the spherical support housing 3 shown in FIGS. 2 and 4 to 7, the transfer surface 53 is formed by parts of the spherical cap 53 itself, so that extensive contact with the transfer surface 34 on the spherical body 21 is made under load, the example of the spherical support housing 3, shown in FIGS. 8 to 10, differs from the above-described example in that the spherical cap parts 53 exhibit an undulated profile 65 that projects radially inward, with the crests 67 (see FIG. 10) forming parts of circular rings that circumscribe a hollow spherical shape. In this case, the circular ring surface parts form the support surface that is adapted to the spherical surface 34 forming the transfer surface on the load bearing member 17.

FIGS. 11 to 13 illustrate an additional embodiment of the spherical support housing 3 that matches in essence the example from FIGS. 8 to 10. However, instead of the undulated profile 65, projections in the form of hemispheres 69 protrude from the cap surface parts 53. In particular, FIG. 13 shows that these hemispheres, which are distributed in an irregular pattern, are distributed over the surface of the cap parts 53 on the bottom part 13 and with their heads circumscribe a spherical surface, which forms the support surface. In the hooked-together state, these hemispheres form contact points on the spherical surface 34 of the spherical part 21 of the load bearing member 17.

FIGS. 14 and 15 show a more modified embodiment of the spherical support housing 3. In contrast to the above-described examples, the spherical support housing 3 is designed as two parts and has two mirror-symmetrical shell-shaped housing halves 71 and 73. They are swivel-mounted on a swivel bearing 75 that is arranged on the housing upper part 5 in proximity to the extensions 7, forming the attachment point for a cable 9. This swivel bearing defines a swivel axis that extends perpendicular to the main axis of the spherical support housing 3. A comparison of FIG. 14 with FIG. 15 shows that the housing halves 71 and 73 can be swiveled between an unhooked position, in which the two halves are swung away from each other, and a hooked position, in which the two halves are swung back together so as to rest against each other. FIG. 15 shows the state of the hooked-together position, in which the spherical part 21 of the load bearing member 17 of the invention is received in the interior of the receiving compartment, formed between the housing halves 71 and 73 that are swung back together so as to rest against each other. FIG. 14 shows the partially hooked-together state, in which one half 71 of the housing is already swiveled into the hooking position, while the other half 73 of the housing is still in a swivel state that corresponds to the unhooking position. In contrast to the above-described examples, in which for the hooking and unhooking process there had to be a relative movement transversely to the main axis in order to push the spherical part 21 into or move the same out of the receiving compartment 5 from the side, the example from FIGS. 14 and 15 makes it possible for the spherical part 21 to overlap directly from the top without the need for a transverse movement.

The inside of the housing halves 71 and 73 that borders the bottom parts 13 and forms the support surface for the interaction with the transfer surface 34 on the spherical part 21 can be formed by spherical cap surfaces in order to rest flush against the transfer surface 34 or can be provided identically with projections, which circumscribe the spherical surface parts, as is the case in the examples from FIGS. 8 to 13.

In order to secure the housing halves 71, 73 in the hooked-together position, there is a metal retaining ring 77 that is shown in the raised release position in FIG. 14. When the housing halves 71, 73 are swung together so as to rest against each other, the retaining ring 77 can be slid onto a cylindrical shell 79, which is formed on the outside of the housing halves 71, 73 in the retracted position and where the retaining ring comes to rest against an annular bead 81 in a securing position.

FIG. 16 shows another embodiment of the load bearing member 17, which differs from the example in FIG. 3 insofar as the transfer surface for the engagement of the tensioning mechanism on the loading bearing member 17 is not formed by a continuous surface, as is the case in the example from FIG. 3, in the form of the spherical surface 34, but rather that in FIG. 16 the load bearing member 17 has a contouring. In the example from FIG. 16, ring ribs 85 are provided for this purpose. These ring ribs extend, based on the axis 29 of the load bearing member 17, in radial planes at a distance from each other and are offset from each other by depressions 89. The peak regions of the ring ribs 85 are circumscribed by a convexly curved envelope. Although this envelope can define a spherical surface, that is to say, a sphere, it can also define an arched surface in the form of a spheroid that deviates from the spherical shape.

FIG. 17 shows an additional example of the load bearing member 17, where there are, instead of the closed ring ribs 85, rib sections 87, which extend from the shank section 19 in a slightly mutually diverging manner and are separated from each other by narrower depressions 89. The outer regions of the ribs 87 are once again circumscribed by an envelope that exhibits a convex curvature.

In the additional embodiment, shown in FIG. 18, the load bearing member 17 has a pattern composed of ribs 85, which extend in radial planes, and depressions 89. These depressions intersect the ribs 85 at an essentially right angle, so that the result is a pattern of peak regions that are separated from each other and that extend in radial planes that are circumscribed by a convex envelope.

In the embodiments 16 to 18, the depressions 89 form receiving compartments, in which any accumulated dirt can be accommodated, if desired, when the load bearing device is put into service. Otherwise, this dirt could have a deleterious effect on the geometry of the interaction between the transfer surface and the support surface of the tensioning mechanism.

FIGS. 19 to 21 illustrate another embodiment of the load bearing device. In this load bearing device the load bearing member 17 can be designed analogous to the examples depicted in the preceding figures. In contrast, the special feature consists of the fact that the tensioning mechanism does not have a spherical support housing 3 in the form of a spherical hook, but rather has, instead, a one-piece casting that is molded in such a way that it forms a spherical eyelet 65. This eyelet has the shape of a noose that is closed at the upper end 67 and that is provided for a loop of the cable 9 (not illustrated). The legs 69, 71 of the noose are configured so as to form the spherical cap parts 53 for the abutment of the transfer surface 34 of the load bearing member 17 (see FIG. 21), thus forming an insert opening between the legs 70 and 71 (see FIG. 19), for hooking the spherical part 21 of the load bearing member 17.

1. A load take-up device for introducing load forces, such as cable forces or tension forces of flat structures, into support structures (10, 41) and that comprises at least one load bearing member (17) which is anchored or is anchorable thereon and which forms at least one transfer surface (34) for the engagement of a tensioning mechanism (1), characterized in that the transfer surface (34) is designed at least partially in a convex manner or is formed by surface areas that are circumscribed by a convexly curved envelope.

2. The load bearing device according to claim 1, characterized in that the part forming the transfer surface of the load bearing member (17) is designed as a spheroid.

3. The load bearing device according to claim 2, characterized in that the transfer surface of the load bearing member (17) is formed by a spherical surface (34) that forms part of a spherical body.

4. The load bearing device according to claim 3, characterized in that the spherical surface (34) is formed on a spherical part (21) that can be connected to the support structure (41) or molded to the same by means of an anchoring element (19).

5. The load bearing device according to claim 2 or 4, characterized in that the surface areas (85, 87), which form the transfer surface and which are circumscribed by a convexly curved envelope, are offset from each other by surface areas (89) that are recessed in the spherical part (21).

6. The load bearing device according to claim 5, characterized in that the surface areas that are offset from each other are formed by elevations (85, 87) that project in a rib-like manner beyond the spherical part and that extend, based on the axis (29) of the anchoring element (19), as closed ring ribs (85) in radial planes at a distance from each other and/or are rib sections (87), which extend from the anchoring element (19) in a mutually diverging manner.

7. The load bearing device according to claim 1, characterized in that the anchoring element that is provided is a shank section (19) that projects beyond an outer surface (43) of the support structure (41) connected to said anchoring element, so that the end of the shank section is attached to the spherical part (21) that is connected as one piece to said shank section.

8. The load bearing device according to claim 7, characterized in that the shank section (19) terminates in a threaded journal (23) that can be screwed together with the support structure (41).

9. The load bearing device according to claim 8, characterized in that the shank section (19) has an expansion in the form of a collar (25) on the end of the threaded journal (23) that is adjacent to the spherical part (21), and that the diameter of the collar is larger than that of the threaded journal (23), and that the collar forms a buttressing surface (27) for resting against the outside (43) of the support structure (41) that is screwed together with the threaded journal (23).

10. The load bearing device according to claim 9, characterized in that the diameter of the collar (25) is preferably about twice the size of the diameter of the threaded journal (23), and that the diameter of the spherical body (21) is preferably about twice the size of the diameter of the threaded journal (23).

11. The load bearing device according to claim 1, comprising a tensioning mechanism (1), which has a spherical hook with a spherical support housing (3), in which the spherical part (21) and a portion of the shank section (19) that is a part of the load bearing member (17) and that borders said spherical part can be accommodated, and that the interior has parts of a spherical cap (53), which forms with its spherical surface parts alone or with surface parts, which project radially from the spherical surface parts, the support surface for the interaction with the transfer surface (34) on the spherical part (21) of the load bearing member (17).

12. The load bearing device according to claim 11, characterized in that the spherical support housing (3) has a receiving compartment (15), which envelops the spherical part (21) and the adjacent shank section (19) in the state of hooking with the load bearing member (17).

13. The load bearing device according to claim 12, characterized in that the spherical support housing (3) is designed like a bell and has an upper part (5), which lies opposite the bottom part (13) and has an engagement point (7) for the tension force, generated by the tensioning mechanism (1), so that the line of action of the tension force defines a main axis of the spherical support housing (3) that extends from the bottom part (13) to the upper part (5).

14. The load bearing device according to claim 13, characterized in that the receiving compartment (15) of the spherical support housing (3) in the hooking-together state surrounds the spherical part (21) while simultaneously leaving open only those recesses (47, 51) that form the access to the receiving compartment (15) for hooking and unhooking the load bearing member (17).

15. The load bearing device according to claim 13, characterized in that the recesses (47, 51) for the movements of the load bearing member (17) into and out of the interior of the spherical support housing (3) prescribe a direction of movement that is perpendicular to the main axis.

16. The load bearing device according to claim 14, characterized in that the recesses have a slit (47), located in the bottom part (13) and having a width that enables the passage of the shank section (19) of the spherical part (21), and an aperture (51) in the side wall (11), said aperture being attached to the slit (47) and enabling the passage of the spherical part (21).

17. The load bearing device according to claim 16, characterized in that the bottom part (13) has spherical cap parts (53), which are attached in a symmetrical arrangement to both edges of the slit (47).

18. The load bearing device according to claim 17, characterized in that the spherical cap parts (53) have circular segments, which exhibit an undulated profile, which projects radially inward, said circular segments forming with their crests the support surface for the interaction with the transfer surface (34) of the spherical part (21).

19. The load bearing device according to claim 17, characterized in that the spherical cap parts exhibit a pattern of radially protruding hemispheres that form the support surface for the interaction with the transfer surface (34) of the spherical part (21).

20. The load bearing device according to claim 15, characterized in that the upper part (5) of the spherical support housing (3) has a flap (55) that can be swiveled about an axis (57) that extends perpendicular to the main axis and to the longitudinal direction of the slit (47), and that this flap can be moved into a position that partially blocks the aperture (41) in order to ensure the hooked-together state, or that this flap can be moved into a position that releases the aperture (51).

21. The load bearing device according to claim 20, characterized in that the flap (55) is biased in the direction of the blocking position.

22. The load bearing device according to claim 13, characterized in that the upper part (5) of the spherical support housing (3) forms a swivel bearing (75), which is connected to the engagement point (7) for the tension force generated by the tensioning mechanism (1), for two shell-shaped housing halves (71, 73), which can be swiveled between an unhooked position, in which the two halves are swung away from each other, and a hooked-together position, in which the two halves are swung back together so as to rest against each other, thus forming the receiving compartment, which in the hooked-together state surrounds the load bearing member (17) while simultaneously releasing only the shank section bordering the spherical part (21).

23. The load bearing device according to claim 22, characterized in that the insides of the housing halves (71, 73) have spherical cap parts for the interaction with the transfer surface (34) of the spherical part (21) located in the receiving compartment.
